(19) United States
(12) Patent Application Publication
(10) Pub. No.: US 2022/0171984 A1
(43) Pub. Date: Jun. 2, 2022

(54) DETERMINATION DIFFERENCE DISPLAY APPARATUS, DETERMINATION DIFFERENCE DISPLAY METHOD, AND COMPUTER READABLE MEDIUM STORING PROGRAM

(71) Applicant: NEC Corporation, Minato-ku, Tokyo (JP)

(72) Inventor: Yusuke TAKAHASHI, Tokyo (JP)

(73) Assignee: NEC Corporation, Minato-ku, Tokyo (JP)

(21) Appl. No.: 17/432,987

(22) PCT Filed: Feb. 28, 2019
(86) PCT No.: PCT/JP2019/007954

§ 371 Date: Aug. 23, 2021

(51) Int. Cl. G06K 9/62; G06N 20/00

(52) U.S. Cl. CPC G06K 9/6201; G06N 20/00; G06K 9/6232

(57) ABSTRACT

In one aspect, a determination difference display apparatus according to the present disclosure includes: a feature vector generation unit (10) that generates a feature vector obtained by converting feature elements of determination target data into a vector form for each of the feature elements; a comparison target selection unit (11) that reads a first weight coefficient of the learned determination model corresponding to a first user and reads a second weight coefficient of the learned determination model corresponding to a second user; and a determination difference presentation unit (13) that presents, as a determination difference element, the feature element constituting a difference in determination between comparison target users based on a difference between the first and the second weight coefficients corresponding to the feature elements.

### TECHNICAL FIELD

The present disclosure relates to a determination difference display apparatus, a determination difference display method, and a computer readable medium and, in particular, to a determination difference display apparatus, a determination difference display method, and a computer readable medium that present a difference in determination between individuals.

### BACKGROUND ART

A large number of methods have been proposed in which human determination is learned by machine learning and various types of determinations are made using results of the learning. In order to acquire a criterion of human determination, a machine learning method for determining a model for mapping results of the human determination as teacher data is used. Such a machine learning method is referred to as supervised learning, and methods for the supervised learning such as a random forest and a support vector machine have been proposed. Further, in the supervised learning, there are parameters that need to be set in advance by a human, and the quality of the model varies depending on these values. In response to this, techniques for determining the qualities of parameters determined by learning are disclosed in Patent Literature 1 and 2.

In the technique disclosed in Patent Literature 1, a learning information storage unit that stores information about at least two or more learning results that have acquired classification ability by machine learning, a determination condition storage unit that stores a classification result equivalence determination condition for determining that classification results output from the at least two or more learning results are equivalent to each other, a classification result input unit that receives the classification results output from the at least two or more learning results, a determination unit that determines whether at least two classification results among the classification results output from the at least two or more learning results are equivalent to each other by using information about the learning results and the classification result equivalence determination condition, and an identification information adding unit that adds the same identification information to the classification results determined to be equivalent to each other, to the learning results that output the classification results determined to be equivalent to each other, or to both of them are provided.

Further, the technique disclosed in Patent Literature 2 is a control device for a robot for performing an operation in cooperation with a person, the control device comprising: a machine learning device including a recognition unit for classifying an action of the person, and a learning unit for learning the action of the person, while the person performs an operation in cooperation with the robot; and an action control unit for controlling the action of the robot based on a result of the classification of the recognition unit.

### CITATION LIST

### Patent Literature

Patent Literature 1: Japanese Unexamined Patent Application Publication No. 2018-045483

Patent Literature 1: Japanese Unexamined Patent Application Publication No. 2018-062016

### SUMMARY OF INVENTION

### Technical Problem

Meanwhile, besides the need to improve the results of machine learning, there is a need to refer to the degree of training of a person or the criterion of a determination of the other persons. For example, there is work in which a human performs classification/determination based on some kind of determination criteria, such as a determination as to whether a product is a good product or a defective product and the alert monitoring of an apparatus for security measures. In such work, there is a need to refer to the criterion of a determination of the other persons, in particular, an experienced operator, when cultivation of an inexperienced operator is performed or it is difficult to make a determination.

However, the techniques disclosed in Patent Literature 1 and 2 have problems that it is not possible to know what kind of criteria the determination of difference in behavior between persons used for machine learning is based on.

### Solution to Problem

In one example aspect, a determination difference display apparatus according to the present disclosure includes: a feature vector generation unit configured to generate a feature vector obtained by converting feature elements of determination target data into a vector form for each of the feature elements, the determination target data being a target of a predetermined determination made by each of users; a learned determination model database storing, in regard to a determination model that includes learning data including the feature elements common to at least part of the determination target data and a weight coefficient corresponding to each of the feature elements of the learning data as parameters and is defined by a determination function for outputting a determination result for the learning data, a plurality of learned determination models in which the weight coefficient is adjusted for each of the users by using the learning data as input and the determination result for the learning data for each of the users as teacher data; a comparison target selection unit configured to read, as a first weight coefficient, the weight coefficient of the learned determination model corresponding to a first user, the learned determination model being a comparison source, and read, as a second weight coefficient, the weight coefficient of the learned determination model corresponding to a second user, the learned determination model being a comparison target; and a determination difference presentation unit configured to present, as a determination difference element, the feature element constituting a difference in determination between the first user and the second user based on a difference between the first and the second weight coefficients corresponding to the feature elements included in the feature vector.

In one example aspect, a determination difference display method according to the present disclosure is a determination difference display method performed in a determination difference display apparatus configured to present a difference between determinations made by respective users for determination target data to be a target of a predetermined determination made by each of the users by using a learned determination model database storing, in regard to a determination model that includes learning data including feature elements common to at least part of the determination target data and a weight coefficient corresponding to each of the feature elements of the learning data as parameters and is defined by a determination function for outputting a determination result for the learning data, a plurality of learned determination models in which the weight coefficient is adjusted for each of the users by using the learning data as input and the determination result for the learning data for each of the users as teacher data, the determination difference display method including: generating a feature vector obtained by converting the feature elements of the determination target data into a vector form for each of the feature elements; reading, as a first weight coefficient, the weight coefficient of the learned determination model corresponding to a first user, the learned determination model being a comparison source; reading, as a second weight coefficient, the weight coefficient of the learned determination model corresponding to a second user, the learned determination model being a comparison target; and presenting, as a determination difference element, the feature element constituting a difference in determination between the first user and the second user based on a difference between the first and the second weight coefficients corresponding to the feature elements included in the feature vector.

In one example aspect, a computer readable medium according to the present disclosure is a computer readable medium storing a program for causing a computer to execute processing for extracting a determination difference element that is a difference between determinations made by respective users, the processing being executed by an arithmetic unit in a determination difference display apparatus configured to present a difference between determinations made by the respective users for determination target data to be a target of a predetermined determination made by each of the users by using a learned determination model database storing, in regard to a determination model that includes learning data including feature elements common to at least part of the determination target data and a weight coefficient corresponding to each of the feature elements of the learning data as parameters and is defined by a determination function for outputting a determination result for the learning data, a plurality of learned determination models in which the weight coefficient is adjusted for each of the users by using the learning data as input and the determination result for the learning data for each of the users as teacher data, the program causing the computer to execute: feature vector generation processing for generating a feature vector obtained by converting the feature elements of the determination target data into a vector form for each of the feature elements; comparison target selection processing for reading, as a first weight coefficient, the weight coefficient of the learned determination model corresponding to a first user, the learned determination model being a comparison source, and reading, as a second weight coefficient, the weight coefficient of the learned determination model corresponding to a second user, the learned determination model being a comparison target; and determination difference presentation processing for presenting, as a determination difference element, the feature element constituting a difference in determination between the first user and the second user based on a difference between the first and the second weight coefficients corresponding to the feature elements included in the feature vector.

### Advantageous Effects of Invention

By the determination difference display apparatus, the determination difference display method, and the determination difference display program according to the present disclosure, it is possible to know the difference in determination criterion between users.

### BRIEF DESCRIPTION OF DRAWINGS

FIG. 1 is a block diagram of a determination difference display apparatus according to a first example embodiment;

FIG. 2 is a diagram for explaining an example of a weight vector stored in a learned determination model database according to the first example embodiment;

FIG. 3 is a diagram for explaining an example of the difference in features between a comparison source model and a comparison target model in the determination difference display apparatus according to the first example embodiment;

FIG. 4 is a flowchart for explaining a procedure for extracting a determination difference element in the determination difference display apparatus according to the first example embodiment;

FIG. 5 is a flowchart for explaining a procedure for displaying the determination difference element in the determination difference display apparatus according to the first example embodiment;

FIG. 6 is a block diagram of a determination difference display apparatus according to a second example embodiment; and

FIG. 7 is a diagram for explaining an example of determination difference information stored in a determination result database of the determination difference display apparatus according to the second example embodiment.

### DESCRIPTION OF EMBODIMENTS

### First Example Embodiment

Hereinafter, example embodiments according the present disclosure will be described with reference to the drawings. A determination difference display apparatus 1 according to a first example embodiment selects, for each operator, determination models between which a comparison is to be made from among the learned determination models that have learned the classification of determination results regarding work, and presents a difference in determination criterion between the operators by comparing the weight coefficients of these determination models. The specific configuration and operation of the determination difference display apparatus 1 will be described below. Note that, in the description of the example embodiments, a description will be given of an example in which only a difference in features included in the determination target data is presented, but comparisons may not be limited to being made between the features included in the determination target data, and instead comparisons may be made between all the features included in the determination models between which a comparison is to be made.

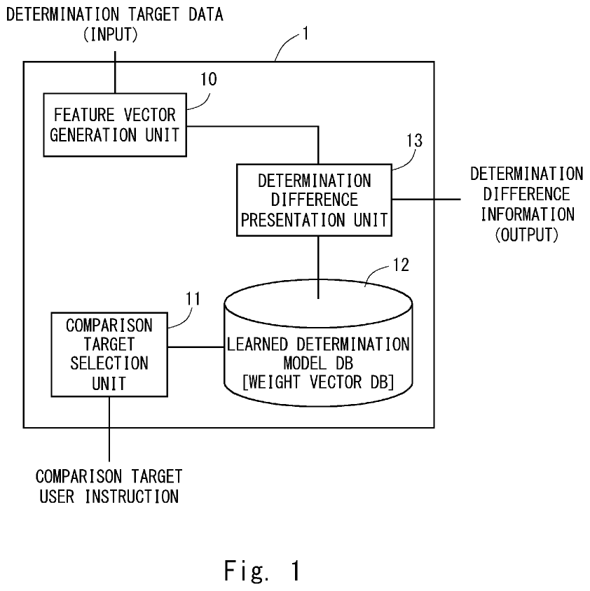

FIG. 1 is a block diagram of the determination difference display apparatus according to the first example embodiment. As shown in FIG. 1, the determination difference display apparatus 1 according to the first example embodiment includes a feature vector generation unit 10, a comparison target selection unit 11, a learned determination model database 12, and a determination difference presentation unit 13.

The feature vector generation unit 10 generates a feature vector obtained by converting feature elements of determination target data to be a target of a predetermined determination made by each user into a vector form for each of the feature elements. It should be noted that the number of feature vectors is the same as the number of feature element parameters included in a determination model described later. However, when a feature corresponding to the parameter in the determination model is not included in the determination target data, a value of the feature that is not included in the determination target data becomes zero.

Further, regarding the conversion of the feature elements into a vector form by the feature vector generation unit 10, it is preferable to perform normalization processing for limiting the range of values that each feature element can take to a fixed range. By performing this normalization processing, a comparison between the weight coefficients of the determination models can be easily made. Further, as a specific method for the feature vector generation unit 10 to convert the feature elements into a vector form, for example, a method can be used in which data to be classified is analyzed for features, such as “including a word W” and “a total number of characters”, and the analyzed features are represented in binary numbers or converted into predetermined values. When the determination target data is a document, a method for representing to which document cluster the determination target data belongs in a vector form can be used as a method for generating a feature vector. Specifically, a document cluster is generated by converting the determination target data into a vector form in advance using a method such as Word2Vec or Doc2Vec and performing clustering. By representing the document cluster to which the determination target data belongs in One-hot form, a feature vector representing the document cluster can be created. The above-described example of the method for converting the feature elements into a vector form is merely an example and other methods may instead be used.

A plurality of learned determination models are stored in the learned determination model database 12. The determination model according to the first example embodiment includes learning data including feature elements common to at least part of the determination target data and a weight coefficient corresponding to each of the feature elements of the learning data as parameters, and is defined by a determination function for outputting a determination result for the learning data. Further, in the first example embodiment, regarding the determination model, the learned determination model is generated by using the learning data as input and the determination result for the learning data for each user as teacher data and adjusting the weight coefficient for each user. The plurality of learned determination models generated for each user are stored in the learned determination model database 12.

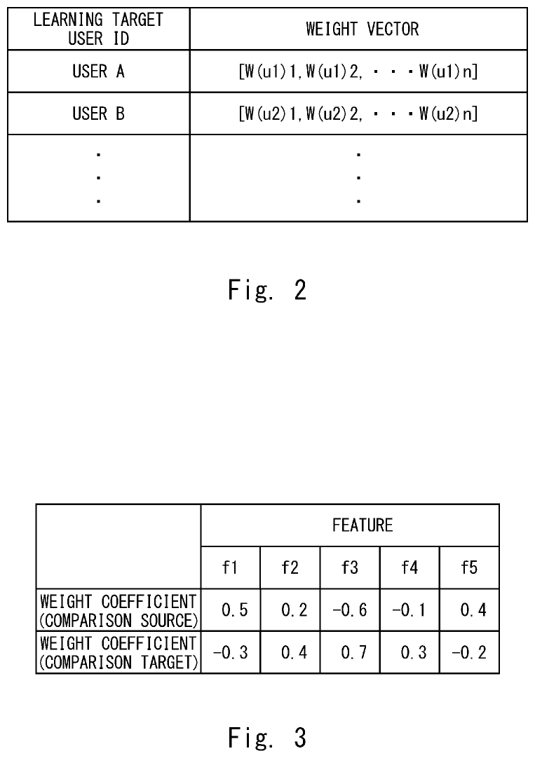

Note that the learned determination model database 12 stores a weight vector indicating a weight coefficient used in the determination model for each user. FIG. 2 is a diagram for explaining an example of the weight vector stored in the learned determination model database according to the first example embodiment. As shown in FIG. 2, an ID that specifies a user corresponding to the learned determination model is described in a learning target user ID, and a weight vector of the learned determination model corresponding to this user ID is described in association with the user.

It is expected that the condition which a learning target user has used as a determination criterion at the time of the classification of the determination target data will be inductively learned as an effective classification condition in the learning process of machine learning. That is, the effective feature for classification is adjusted to a value having a large weight coefficient, and therefore, by comparing the weight coefficients of the learned determination models for respective learning target users with each other, it is possible to indicate the difference in determination criterion between the learning target users at the time of the classification of the determination target data.

The comparison target selection unit 11 reads, as a first weight coefficient, the weight coefficient of the learned determination model corresponding to a first user, the learned determination model being a comparison source, and reads, as a second weight coefficient, the weight coefficient of the learned determination model corresponding to a second user, the learned determination model being a comparison target. Specifically, the comparison target selection unit 11 receives an instruction regarding users with whom a comparison is made from the outside. Then the learned determination model database 12 gives, based on the specified users, user IDs for specifying the first user and the second user to the learned determination model database 12. Then the learned determination model database 12 outputs, to the determination difference presentation unit 13, weight vectors corresponding to the respective user IDs which the comparison target selection unit 11 has given.

The determination difference presentation unit 13 compares the first weight coefficient of the learned determination model corresponding to the first user with the second weight coefficient of the learned determination model corresponding to the second user. Then the determination difference presentation unit 13 presents a feature element constituting a difference in determination between the first user and the second user as a determination difference element based on a difference between the weight coefficients corresponding to the feature elements included in the feature vector.

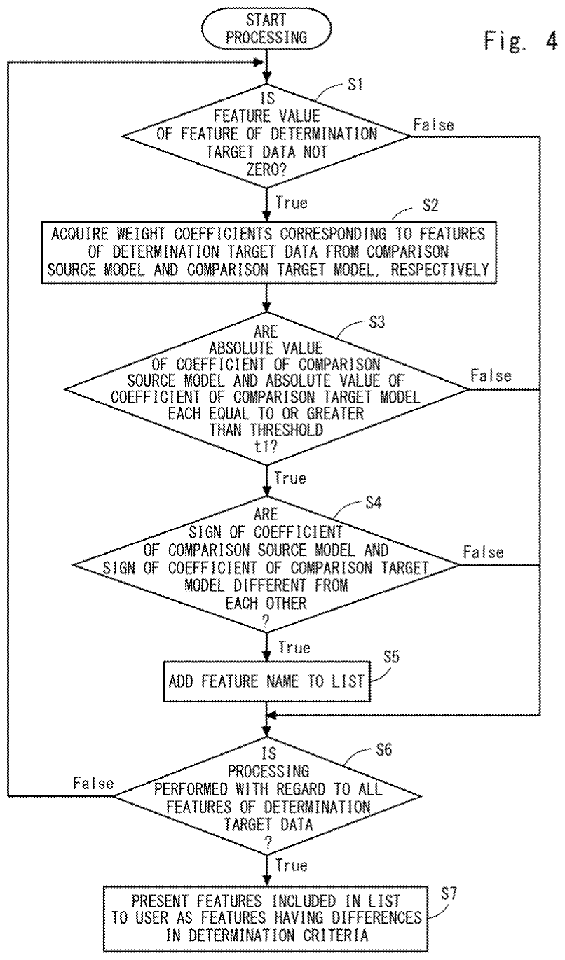

The weight coefficients to be compared in the determination difference presentation unit 13 will be described below. FIG. 3 is a diagram for explaining an example of the difference in features between a comparison source model and a comparison target model in the determination difference display apparatus according to the first example embodiment. In the example shown in FIG. 3, the feature vector generated by the feature vector generation unit 10 includes feature elements f1 to f5. Further, in the example shown in FIG. 3, the determination difference presentation unit 13 extracts the weight coefficients corresponding to the feature elements f1 to f5 from each of the learned determination model (hereinafter referred to as the comparison source model) corresponding to the first user and the learned determination model (hereinafter referred to as the comparison target model) corresponding to the second user. In the example shown in FIG. 3, there is a difference in weight coefficients between the comparison source model and the comparison target model. Regarding this difference, a feature of the comparison target model in which the sign of the coefficient is different from that of the feature of the comparison source model indicates a feature that is a criterion opposite to that of the comparison source model. Further, it can be considered that a feature element having a large weight coefficient is a feature element having a high level of importance in the determination. The determination difference presentation unit 13 outputs a determination difference element to the outside based on the difference in the magnitudes of the weight coefficients for the respective feature elements. Processing for presenting a determination difference element in the determination difference presentation unit 13 according to the first example embodiment will be described below.

FIG. 4 is a flowchart for explaining a procedure for extracting a determination difference element in the determination difference display apparatus according to the first example embodiment. The flowchart in FIG. 4 shows processing performed after the feature vector generation unit 10 generates a feature vector. Further, in the operation example shown in FIG. 4, a plurality of feature elements included in the determination target data are verified sequentially one by one whether or not it is to be displayed. Further, the operation example shown in FIG. 4 mainly describes the processing performed in the determination difference presentation unit 13.

As shown in FIG. 4, in the determination difference display apparatus 1 according to the first example embodiment, first, the determination difference presentation unit 13 verifies the size of each of the feature elements of the determination target data by referring to the respective feature vectors generated by the feature vector generation unit 10 (Step S1). Then, if the size of a feature element of the determination target data is zero (False in Step S1), the determination difference presentation unit 13 verifies the next feature element (False in Step S6). On the other hand, if the size of the feature element of the determination target data is not zero (Ture in Step S1), the determination difference presentation unit 13 performs the processing of Step S2.

In Step S2, the determination difference presentation unit 13 acquires weight coefficients corresponding to the feature elements of the determination target data from the comparison source model and the comparison target model, respectively. Next, regarding the weight coefficients extracted in Step S2, the determination difference presentation unit 13 verifies whether or not the absolute value of the magnitude of the weight coefficient (e.g., the first weight coefficient) of the comparison source model and the absolute value of the magnitude of the weight coefficient (e.g., the second weight coefficient) of the comparison target model are each equal to or greater than a preset first threshold (e.g., a threshold t1) (Step S3).

In Step S3, if at least one of the first weight coefficient of the comparison source model and the second weight coefficient of the comparison target model is less than the threshold t1, the determination difference presentation unit 13 verifies the next feature element (False in Step S6). On the other hand, if both the first weight coefficient of the comparison source model and the second weight coefficient of the comparison target model are equal to or greater than the threshold t1 (Ture in Step S4), the determination difference presentation unit 13 verifies whether the sign of the first weight coefficient of the comparison source model and the sign of the second weight coefficient of the comparison target model are different from each other (Step S4).

In Step S4, if the sign of the first weight coefficient of the comparison source model and the sign of the second weight coefficient of the comparison target model coincide with each other, the determination difference presentation unit 13 verifies the next feature element (False in Step S6). On the other hand, if the sign of the first weight coefficient of the comparison source model and the sign of the second weight coefficient of the comparison target model are different from each other (Ture in Step S5), the determination difference presentation unit 13 adds the feature element to be processed in the current processing cycle to the list as a feature to be presented to a user (Step S5). Then, in the determination difference display apparatus 1 according to the first example embodiment, the processing of Steps S1 to S5 is performed with regard to all the feature elements of the determination target data (Step S6). Further, after the processing of Steps S1 to S5 is performed with regard to all the feature elements, the determination difference presentation unit 13 presents the feature elements included in the list to the user as determination difference elements having differences in determination criteria between the first user and the second user (Step S7).

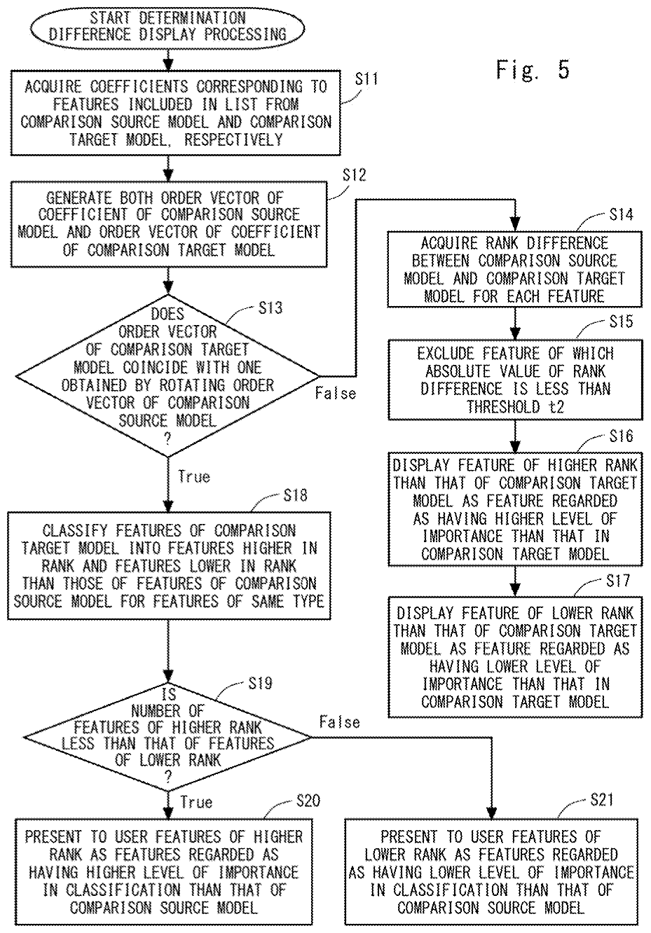

It should be noted that, in the presentation processing in Step S7, it is not only possible to present the list of the determination difference elements, but also to present how the first user and the second user differ from each other in the determination difference elements. Therefore, a method for displaying the determination difference element in the determination difference presentation unit 13 will be described in detail below. FIG. 5 is a flowchart for explaining a procedure for displaying the determination difference element in the determination difference display apparatus according to the first example embodiment. Note that, in the display procedure described below, a comparison between the order vectors is made. The comparison of the order vectors of the coefficients is intended to show the feature that is based on the same criteria as that of the comparison source but is of a different level of importance.

The processing shown in FIG. 5 is mainly performed by the determination difference presentation unit 13. As shown in FIG. 5, when the determination difference display processing is started, the determination difference presentation unit 13 first acquires weight coefficients corresponding to the feature elements included in the list created in Step S5 of FIG. 4 from the comparison source model and the comparison target model, respectively (Step S11).

Next, the determination difference presentation unit 13 generates both an order vector of the first weight coefficient of the comparison source model and an order vector of the second weight coefficient of the comparison target model (Step S12). The order vector is obtained by, for example, sorting each weight coefficient in an ascending or a descending order in accordance with the magnitude of the value, and setting a vector value indicating the order to each weight coefficient in accordance with the sorted order.

Next, the determination difference presentation unit 13 verifies whether or not the order vector of the comparison source model coincides with the one obtained by rotating the order vector of the comparison target model (Step S13). In this Step S13, if the order vector of the comparison source model does not coincide with the one obtained by rotating the order vector of the comparison target model (False in Step S13), the processing in Steps S14 to S17 is performed. In the processing of Steps S14 to S17, among the feature elements moved to the upper or lower position by the rotation, the feature elements of which the numbers are smaller than those of the other feature elements are displayed as the features which the second user of the comparison target model has regarded as having a higher or lower level of importance in the classification than the first user of the comparison source model has.

In the processing of Step S14, the determination difference presentation unit 13 acquires a rank difference between the comparison source model and the comparison target model for each feature element. Next, the determination difference presentation unit 13 excludes the feature element of which the absolute value of the rank difference is less than a second threshold (e.g., a threshold t2) (Step S15). Next, the determination difference presentation unit 13 displays a feature of the comparison source model of a higher rank than that of the comparison target model as a determination difference element regarded as having a higher level of importance in the comparison source model than that in the comparison target model (Step S16). Further, the determination difference presentation unit 13 displays a feature of the comparison source model of a lower rank than that of the comparison target model as a determination difference element regarded as having a lower level of importance in the comparison source model than that in the comparison target model (Step S17).

Meanwhile, if it is determined in Step S13 that the order vector of the comparison source model coincides with the one obtained by rotating the order vector of the comparison target model (Ture in Step S13), the determination difference presentation unit 13 classifies the feature elements of the comparison target model into feature elements higher in rank and feature elements lower in rank than those of the feature elements of the comparison source model for the feature elements of the same type (Step S18).

Next, if the number of feature elements of a higher rank is less than that of feature elements of a lower rank (Ture in Step S19), the determination difference presentation unit 13 presents to a user the features of a higher rank as feature elements regarded as having a higher level of importance in the classification than that of the comparison source model (Step S20). If the number of feature elements of a higher rank is greater than that of feature elements of a lower rank (False in Step S19), the determination difference presentation unit 13 presents to a user the features of a lower rank as feature elements regarded as having a lower level of importance in the classification than that of the comparison source model (Step S21).

According to the above description, in the learned determination model used in the determination difference display apparatus 1 according to the first example embodiment, the weight coefficients included in the model include the factor of the difference between the determinations for respective users. Further, in the determination difference display apparatus 1 according to the first example embodiment, the weight coefficients of the learned determination models of different users are compared for each feature factor, and the feature factors corresponding to the weight coefficients different from each other are extracted, whereby it is possible to know the factor of the difference between the determinations made by users who are to be compared with each other.

As described above, by recognizing the difference in criterion between the determinations made by respective users for the determination target data, it is possible to improve the proficiency level of an operator by learning the difference between the user's determination and a determination made by another person. Further, by recognizing the difference in criterion between the determinations made by respective users for the determination target data, it is possible to consider the success or failure of the user's determination by referring to a determination made by another person.

### Second Example Embodiment

In a second example embodiment, a determination difference display apparatus 2 which is a modified example of the determination difference display apparatus 1 according to the first example embodiment will be described. Note that the same components as those described in the first example embodiment are denoted by the same reference numerals as those in the first example embodiment, and the descriptions thereof will be omitted.

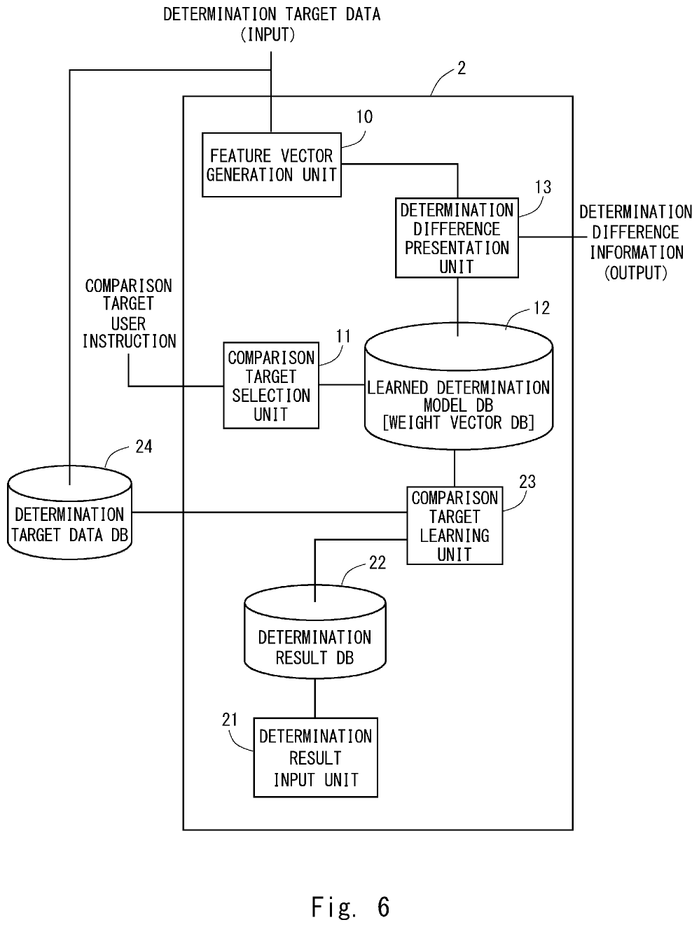

FIG. 6 is a block diagram of the determination difference display apparatus according to the second example embodiment. As shown in FIG. 6, the determination difference display apparatus 2 according to the second example embodiment is similar to the determination difference display apparatus 1 according to the first example embodiment except that a determination result input unit 21, a determination result database 22, and a comparison target learning unit 23 are added. Further, the determination difference display apparatus 2 according to the second example embodiment acquires determination target data from a determination target data database 24 provided outside the determination difference display apparatus 2. The determination target data database 24 accumulates determination target data given to the feature vector generation unit 10.

The determination result input unit 21 is a user interface through which a user inputs a determination result for the determination target data. The determination result database 22 associates a determination result input from the determination result input unit 21 with a user who has input the determination result, and stores determination result information corresponding to the determination target data for each user. An example of the determination result information will be described below.

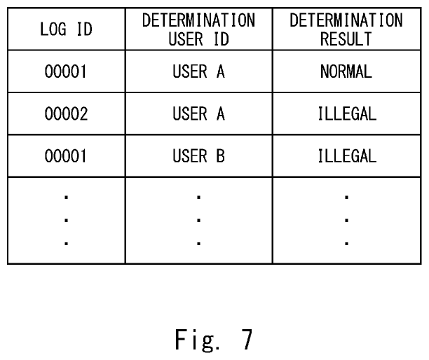

FIG. 7 is a diagram for explaining an example of determination difference information stored in the determination result database of the determination difference display apparatus according to the second example embodiment. As shown in FIG. 7, in the determination result difference information, ID information for specifying the determination target data is described as a log ID, an ID for specifying a user who has input the determination result is described as a determination user ID, and the determination result corresponding to the determination target data is described as a determination result.

Next, the comparison target learning unit 23 generates a learned determination model for each user based on the determination target data read from the determination target data database 24 and the determination result information pieces accumulated in the determination result database 22. Then the comparison target learning unit 23 stores the generated learned determination model in the learned determination model database 12. Note that the comparison target learning unit 23 can also read the learned determination model stored in the determination result database 22 and then perform additional learning based on the determination result read from the determination result database 22.

As described above, the determination difference display apparatus 2 according to the second example embodiment includes the determination result input unit 21, the determination result database 22, and the comparison target learning unit 23, whereby it is possible to generate a new learned determination model and update the learned determination model stored in the learned determination model database 12. Further, this configuration enables the determination difference display apparatus 2 according to the second example embodiment to refer to new determination criteria of users. Further, by performing additional learning on the learned determination model of the learned determination model database 12, it is possible to further increase the accuracy of the determination criterion to be referred to.

Note that the present disclosure is not limited to the above-described example embodiments and may be modified as appropriate without departing from the spirit of the present disclosure.

In the above-described examples, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

### REFERENCE SIGNS LIST

1 DETERMINATION DIFFERENCE DISPLAY APPARATUS

2 DETERMINATION DIFFERENCE DISPLAY APPARATUS

10 FEATURE VECTOR GENERATION UNIT

11 COMPARISON TARGET SELECTION UNIT

12 LEARNED DETERMINATION MODEL DATABASE

13 DETERMINATION DIFFERENCE PRESENTATION UNIT

21 DETERMINATION RESULT INPUT UNIT

22 DETERMINATION RESULT DATABASE

23 COMPARISON TARGET LEARNING UNIT

24 DETERMINATION TARGET DATA DATABASE

What is claimed is:

1. A determination difference display apparatus comprising:
a feature vector generation unit configured to generate a feature vector obtained by converting feature elements of determination target data into a vector form for each of the feature elements, the determination target data being a target of a predetermined determination made by each of users;
a learned determination model database storing, in regard to a determination model that includes learning data including the feature elements common to at least part of the determination target data and a weight coefficient corresponding to each of the feature elements of the learning data as parameters and is defined by a determination function for outputting a determination result for the learning data, a plurality of learned determination models in which the weight coefficient is adjusted for each of the users by using the learning data as input and the determination result for the learning data for each of the users as teacher data;
a comparison target selection unit configured to read, as a first weight coefficient, the weight coefficient of the learned determination model corresponding to a first user, the learned determination model being a comparison source, and read, as a second weight coefficient, the weight coefficient of the learned determination model corresponding to a second user, the learned determination model being a comparison target; and
a determination difference presentation unit configured to present, as a determination difference element, the feature element constituting a difference in determination between the first user and the second user based on a difference between the first and the second weight coefficients corresponding to the feature elements included in the feature vector.

2. The determination difference display apparatus according to claim 1, wherein the determination difference presentation unit extracts, as the determination difference element, a weight coefficient in which the first weight coefficient and the second weight coefficient are different in signs.

3. The determination difference display apparatus according to claim 2, wherein the determination difference presentation unit extracts, as the determination difference element, a feature element corresponding to a weight coefficient in which the first weight coefficient and the second weight coefficient are different in signs and in which each of the first weight coefficient and the second weight coefficient is a value having a magnitude equal to or greater than a preset first threshold.

4. The determination difference display apparatus according to claim 1, wherein the determination difference presentation unit generates an order vector by rearranging the first weight coefficient and the second weight coefficient in an ascending or a descending order, and extracts the determination difference element based on the order vector.

5. The determination difference display apparatus according to claim 4, wherein the determination difference presentation unit refers to the order vector and extracts, as the determination difference element, a feature element in which the absolute value of a rank difference of a part corresponding to each of the feature elements of the same type is greater than a preset second threshold.

6. The determination difference display apparatus according to claim 1, further comprising:
a determination result input unit configured to input a determination result for the determination target data;
a determination result database configured to accumulate determination result information corresponding to the determination target data for each of the users; and
a comparison target learning unit configured to generate the learned determination model for each of the users based on the determination target data and the determination result information pieces accumulated in the determination result database.

7. A determination difference display method performed in a determination difference display apparatus configured to present a difference between determinations made by respective users for determination target data to be a target of a predetermined determination made by each of the users by using a learned determination model database storing, in regard to a determination model that includes learning data including feature elements common to at least part of the determination target data and a weight coefficient corresponding to each of the feature elements of the learning data as parameters and is defined by a determination function for outputting a determination result for the learning data, a plurality of learned determination models in which the weight coefficient is adjusted for each of the users by using the learning data as input and the determination result for the learning data for each of the users as teacher data, the determination difference display method comprising:
generating a feature vector obtained by converting the feature elements of the determination target data into a vector form for each of the feature elements;
reading, as a first weight coefficient, the weight coefficient of the learned determination model corresponding to a first user, the learned determination model being a comparison source;
reading, as a second weight coefficient, the weight coefficient of the learned determination model corresponding to a second user, the learned determination model being a comparison target; and
presenting, as a determination difference element, the feature element constituting a difference in determination between the first user and the second user based on a difference between the first and the second weight coefficients corresponding to the feature elements included in the feature vector.

8. A non-transitory computer readable medium storing a program for causing a computer to execute processing for extracting a determination difference element that is a difference between determinations made by respective users, the processing being executed by an arithmetic unit in a determination difference display apparatus configured to present a difference between determinations made by the respective users for determination target data to be a target of a predetermined determination made by each of the users by using a learned determination model database storing, in regard to a determination model that includes learning data including feature elements common to at least part of the determination target data and a weight coefficient corresponding to each of the feature elements of the learning data as parameters and is defined by a determination function for outputting a determination result for the learning data, a plurality of learned determination models in which the weight coefficient is adjusted for each of the users by using the learning data as input and the determination result for the learning data for each of the users as teacher data, the program causing the computer to execute:
feature vector generation processing for generating a feature vector obtained by converting the feature elements of the determination target data into a vector form for each of the feature elements;
comparison target selection processing for reading, as a first weight coefficient, the weight coefficient of the learned determination model corresponding to a first user, the learned determination model being a comparison source, and reading, as a second weight coefficient, the weight coefficient of the learned determination model corresponding to a second user, the learned determination model being a comparison target; and
determination difference presentation processing for presenting, as a determination difference element, the feature element constituting a difference in determination between the first user and the second user based on a difference between the first and the second weight coefficients corresponding to the feature elements included in the feature vector.
